(19) United States
(12) Patent Application Publication
(10) Pub. No.: US 2021/0056475 A1
(43) Pub. Date: Feb. 25, 2021

(54) OPTIMAL RISK MANAGEMENT

(71) Applicants: Jigar N. Patel, West Chester, OH (US); Pranav N. Patel, West Chester, OH (US)

(72) Inventors: Jigar N. Patel, West Chester, OH (US); Pranav N. Patel, West Chester, OH (US)

(21) Appl. No.: 16/545,725

(22) Filed: Aug. 20, 2019

(51) Int. Cl. G06Q 10/06; G06Q 40/00

(52) U.S. Cl. CPC G06Q 10/0635; G06Q 40/125; G06Q 10/0637

(57) ABSTRACT

A method for optimal risk management is disclosed. The method involves deriving a risk score for a risk element by using various parameters that either indicate probability of risk materializing or potential impact if the risk actually materialized. The method also includes deriving ROI Index for each potential management action by calculating potential change in risk score and estimating cost of implementing the management action. The ROI Indexes are used to prioritize and select the optimal risk management strategies. The method further involves deriving risk scores for all risk categories. The method also includes prioritizing and selecting management actions from all risk categories.

### BACKGROUND

Various aspects of the present disclosure relate generally to managing at least one risk within at least one risk category, and more particularly to selecting and prioritizing at least one optimal solution for each risk, and assigning priority orders to all solutions and respective risks within a given risk category and also to all risk categories by considering effectiveness and cost efficiency.

Risk management practices are in some cases highly dependent on statistically estimating potential risks by having historical log of adverse events and their respective impacts. Accordingly, entities lacking such historical information for accurately estimating risks or being susceptible to at least one completely new risk may implement alternative method to ensure effective, efficient and adaptive risk management.

### BRIEF SUMMARY

According to aspects of the present disclosure, a process for return on investment (ROI) minded risk management is disclosed. The process includes first identifying a risk within a risk category and then assigning it a risk score as proxy of the risk based on its risk profile. The risk profile includes two or more parameters, some indicating the probability of risk materializing and others potential impact of the risk if materialized. The composite risk score is derived using the values of these parameters. The parameters are actively monitored for their values with changing conditions.

Moreover, the process involves assigning at least one management action to at least one risk or risk driving parameter that either remediates or mitigates the risk(s) or prescribes a response action if the risk(s) materialized into an actual adverse event. The management action, if in place, could reduce the risk score by reducing either the probability of risk materializing or potential impact if the risk materialized; the resultant reduced risk score serves as a proxy for residual risk. In this regard, each management action has an associated cost of implementation assigned thereto.

In addition, the process includes calculating ROI Index for each management action impacting at lease one risk or risk driving parameter by considering initial risk score(s), expected reduced risk score(s) and cost of implementing the management action.

Further according to aspects of the present disclosure, ROI Indexes are calculated for all potential management actions. The process involves prioritizing one or more management actions from the highest to the lowest ROI Index. Further, the process includes selecting at least one of the highest ROI Index, preferably the highest ROI Index one(s), management actions as optimal solutions for risk management based on the budget availability.

Further, the process involves using the resultant ROI Indexes to assign priority orders to all management actions. The ROI Indexes for all identified actions and risks within a risk category are further normalized, if required, for prioritizing risks across all risk categories.

BRIEF DESCRIPTION OF THE SEVERAL VIEWS OF THE DRAWINGS

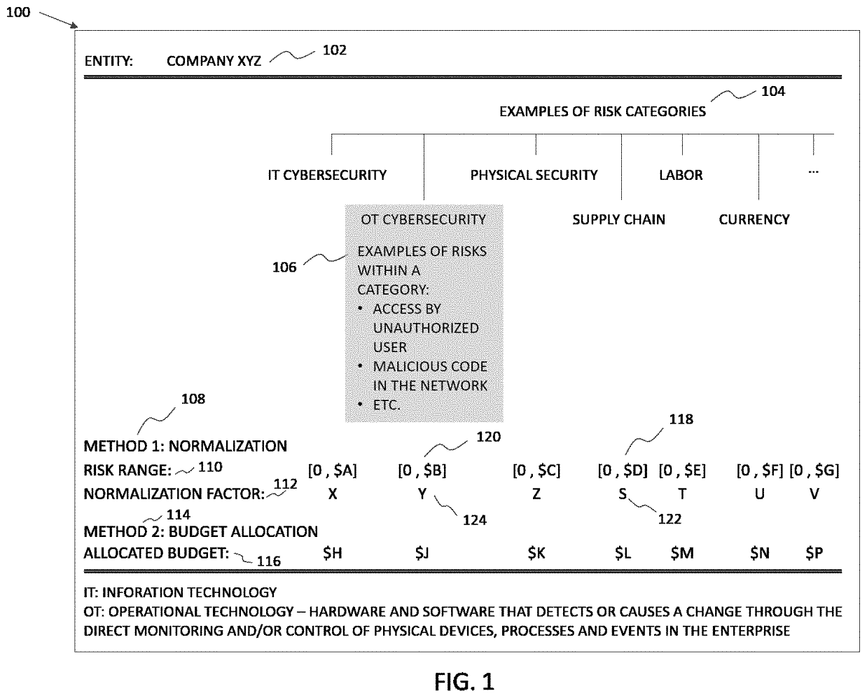

FIG. 1 illustrates an example of various risk categories and budget allocation for risk management in an entity according to aspects of the present disclosure;

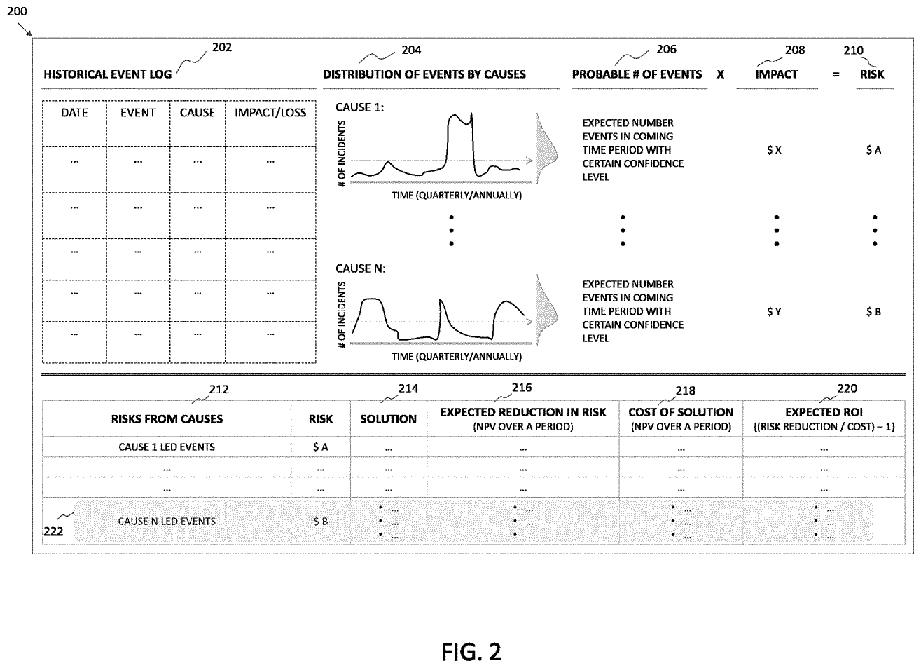

FIG. 2 illustrates an example of a risk quantification and ROI calculation method according to aspects of the present disclosure;

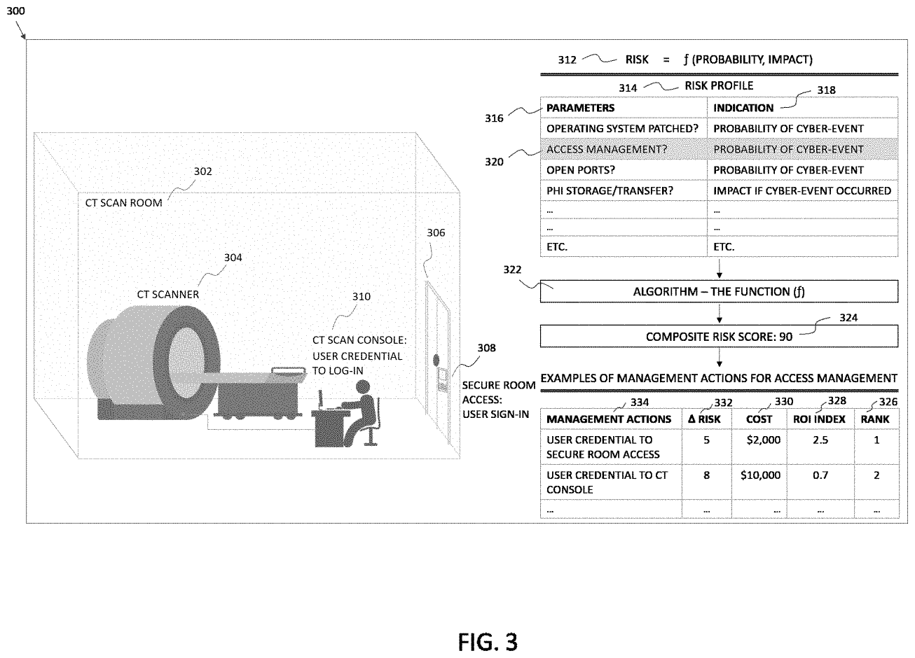

FIG. 3 illustrates a system and process of prioritizing and selecting optimal risk management solutions for a risk element via an example according to various aspects of the present disclosure; and

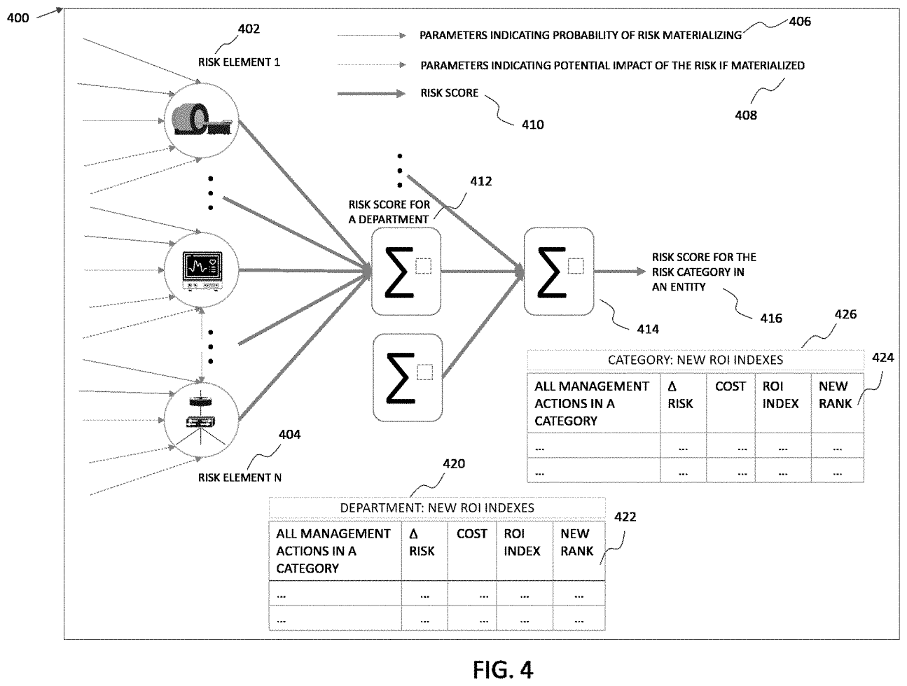

FIG. 4 illustrates an example of generating risk score at a category level according to various aspects of the present disclosure.

### DETAILED DESCRIPTION

Introduction

Various aspects of the present disclosure are generally directed toward improving risk management. In addition, further aspects of the present disclosure are generally directed to adaptable risk management by at least prioritizing one management action for at least one risk element as an optimal solution by considering effectiveness of the solution and cost efficiency in implementation. The present invention is described in enabling detail in the following examples, which may represent more than one embodiment of the present invention.

From a practical standpoint, nearly every entity including corporations, associations, government organizations, small businesses, independent contractors, and every day individuals are exposed to various risks. Every project in an entity also faces some degree of risk. Risk represents at least one potential event with associated one or more negative consequences. Hence, all entities directly, indirectly or intuitively are challenged to identify and manage the risks faced by them.

As a result, many entities seek to identify potential events with associated negative consequences. They further seek to understand probabilities of such risks materializing, and potential impact if the risks actually materialized from the risk management standpoint. For example, a risk with a very low probability of occurring but with a very high cost impact could lead to a crisis.

As described in greater detail herein, risk management could be better facilitated by quantifying impact of the risk, especially in monetary terms. In this regard, an entity may choose not to implement a solution if cost of implementation is greater than the actual risk. Lack of risk quantification may lead to potential implementation of a solution that costs more than the actual risk, inability to measure how much risk is reduced or eliminated via a solution, or even inability to prioritize which one of the risks to address first in case of limited resources.

While entities can identify risks, they often struggle to quantify the risks appropriately in absence of historical data. One of the possible reasons is inadequate processes, talent and infrastructure to report, capture, store and analyze historical events and their impacts. There are also many other emerging risks including but not limited to cybersecurity, black swan, major political or social events that have very little if any historical references to guide quantification process. Entities increasingly have to also plan management actions for these “difficult to quantify” risks. A management action is a response mechanism through which risk is avoided, accepted, transferred, remediated or mitigated. Hence, it could be a solution/control. One example of management action could be having an incident response process if an anticipated risk materialized into an actual adverse event.

Many entities rely on probability-impact matrix or its close variants, where they qualitatively map risks on a matrix with probability being on one axis and impact on the other axis, to plan relevant risk management activities. Each axis could have high, medium and low levels, or have some other qualitative numerical ratings. The matrix is used to prioritize risk management activities. For example, the highest risk, the risk that aligns closest to the highest probability of occurring and having the highest negative impact, is prioritized over a lower risk for control implementation. This is especially more prevalent for “difficult to quantify” risks.

The method, however, faces many challenges, such as:
Prioritization: The method may prioritize control mechanisms for the highest risk as per the mapping on the probability-impact matrix. There could, however, be a high enough risk but lower than the highest risk that can be controlled more effectively at a much lower cost. There could also be a scenario in which addressing this lower risk would not only reduce overall risk for the entity more than the available solution for addressing the highest risk but also cost less. This is essentially the concept of ROI mindset in risk management that is missing in the current method.
Mapping of drivers to risks: The method is appropriate for understanding risks at a high level. More often than not, smaller contributing elements are the drivers for many risks. There could be scenarios in which placing controls at these smaller elements might be more effective and cost efficient. Lack of proper mapping of risks with contributing elements makes risk management inefficient and ineffective.
Control selection: The lack of good risk quantification inherent in the above method makes assessment of effectiveness of potential control mechanisms difficult. There could be more than one risk control mechanisms for a given risk. Effective risk management depends on gaining good indication of how much risk could be mitigated by a given control. Gage R&R challenge involved in the method makes selection of the best control difficult.

Thus, the present disclosure is directed towards processes and systems for ROI minded risk management. Further, aspects of the present disclosure are directed toward gathering and actively monitoring values of various risk contributing parameters to quantify degree of risk, generating ROI Indexes for all potential controls or management actions by taking cost of implementation into account, and prioritizing or selecting optimal solutions for far more cost efficient and effective risk management, even for difficult to quantify risks.

Enterprise Risk Management

Referring now to the drawings and in particular to FIG.1, a method 100 is illustrated according to various aspects of the present disclosure. The illustrated method 100 can be used to categorize and normalize various risks for comparison and prioritization of management actions (i.e. controls) based on availability of resources (i.e. budget).

In this example, the given entity 102 may be exposed to many different types of risks. The risk categories 104 represent types of risks faced by the entity 102 such as supply chain risk, labor risk, currency risk, Operational Technology (OT) cybersecurity risk, etc. Operational Technology (OT) refers to hardware and software that detects or causes a change through the direct monitoring and/or control of physical devices, processes and events in the enterprise. The scale of risk in each category might differ. For example, the worst-case supply chain category risk might be $D 118 versus an OT cybersecurity risk could be $B 120. Each risk category would have at least one risk and/or risk contributing element. Examples of risks 106 within OT cybersecurity category include unauthorized access, malicious code in the network, etc.

In various embodiments, the method 100 comprises normalizing risk scores across various risk categories 104 to enable prioritization of management actions based on budget constraints. The normalization can happen in multiple ways. For example, one method 108 involves developing normalization factor based on the highest of the worst-case risk values of all risk categories 104. In the given example, Y 124 and S 122 for OT cybersecurity and supply chain categories respectively represent the normalization factors. A normalization factor may be a multiplier to either scale up or down all risk scores as described in subsequent sections.

One of the other methods could use executive led budget allocation 114 for management action prioritization and risk management within each category. The budget allocation might take place using probability-impact matrix or its close variant. The resultant allocated budget 116 for OT cybersecurity could be $J in the give example.

Budget and/or other resource constraints at the entity 102 level and by risk categories 104 can be used to aid selection and prioritization of risk management actions for effectiveness.

Risk Management within a Category

In multiple embodiments, where historical log of adverse events and their respective cost impact data are available, risks can be statistically quantified. Now to FIG. 2, a method 200 of statistically quantifying risks, for example, within a risk category and deriving expected ROI from one or more potential management actions is disclosed.

The historical adverse event log 202 could be available for an entity or a group of entities. The event log 202 could contain specific information for each event such as date when the event took place, description of the event, what caused the event to occur, and monetary value (i.e. loss) associated with the event. For each cause, two probability distributions can be created. One probability distribution 204 could help estimate how many events 206 are likely to occur in an upcoming period of time with a given confidence level; this probability distribution 204 could be generated by looking at number of historical events associated with the given root cause over a set of periods (i.e. # of events vs. time graph or table where time could be, for example, in months or quarters). The other probability distribution could help estimate how big of an impact 208 (i.e. monetary loss) each event would have with a given confidence level. The probable number of events 206 from the given root cause and the associated impact 208 potential would provide a value for the risk 210. Hence, aspects of process 200 contribute to quantifying risks 210 associated with each root cause 212.

Further according to aspects of the present disclosure, the process involves assigning at least one management action (i.e. solution 214) to at least one risk that either mitigates the risk(s) or prescribes a response action if the risk(s) materialized into an actual adverse event. The management actions, if in place, are intended to reduce the risk by reducing either the probability of risk materializing or potential impact if the risk materialized. There is also a cost of implementation associated with each management action (i.e. cost of solution 218). Hence, various aspects of the method 200 involves computing expected ROI 220 for all potential management actions for all risks using the risk reduction values 216 and the costs of solutions 218 associated with each management action. These values could also be presented in form of Net Present Values (NPV) of future value streams.

As depicted in FIG. 2, for example, there could be multiple management actions to address risk originating from cause N 222. A user could choose to deploy at least one management action to reduce the risk originating from cause N by selecting from highest expected ROI management actions depending on various resource constraints (i.e. budget). A user may also choose to accept the risk depending on availability of resources, significance of the risk, and level of expected ROI.

In various embodiments, a user can prioritize management actions from the pool of all risks based on expected ROI values; higher the expected ROI value, higher the priority a management action generally takes.

Risk Management Example for a Difficult to Quantify Risk

According to aspects of the present disclosure, entities or situations lacking historical information for estimating risks, being susceptible to at least one completely new risk or facing “difficult to quantify” risks may implement alternative method to ensure effective, efficient and adaptive risk management.

For clarity of discussion and for convenience of illustration, cybersecurity risk of connected medical devices from the medical industry (i.e. hospitals and other healthcare organizations) as a type of OT devices are considered as an example herein. However, the present disclosure can be applied to numerous entities in different industries and situations for optimal risk management.

Now in FIG. 3, a process 300 of prioritizing and/or selecting optimal risk management solution(s) for a risk element is disclosed. The network connected computerized tomography (CT) scanner 304 in FIG. 3 is a risk element. It is an example of a risk element within OT cybersecurity risk category according to various aspects of the present disclosure.

The CT scanner 304 may be located in a room 302. It is often connected to a CT scan console.

The network connected CT scanner 304 may be subject to various cyberattacks. A cyberattack on the CT scanner 304 could lead to a downtime of the scanner, adverse patient impact due to potential malfunction of the scanner or could serve as a gateway to the hospital network. Hence, the network connected CT scanner 304 is a risk element with a varied degree of impact potential. Lack of historical data on cyber-events impacting the CT scanner 304 would make quantification of expected risk difficult. In various embodiments, risk score and ROI Index can be used for optimal risk management in such cases, or for ease of the effort without sacrificing effectiveness.

Referring to FIG. 3, the process 300 comprises of developing a proxy for risk. As shown, risk 312 is a function of at least probability of a cyber-attack taking place with negative consequences and potential impact if the attack actually materialized. The process 300 also comprises of identifying various parameters 316 affecting cybersecurity of the CT scanner 304 and building a cyber risk profile 314. The risk profile 314 may include multiple parameters 316, some indicating 318 the probability of risk materializing and others potential impact of the risk if it materialized. Examples of parameters 316 that indicate 318 probability of a cyber-event include whether the operating system of the CT scanner 304 is patched, whether the CT scanner 304 has some level of access management 320, if the CT scanner 304 has any open ports, etc. For example, if the CT scanner 304 has unpatched operating system, it increases the probability of a cyber-attack materializing. Similarly, if the CT scanner 304 didn't have access management 320, it would also increase the probability of facing a cyber-event by having an unauthorized user gaining access to the system. An example of a parameter 317 that could indicate 318 potential impact of the risk is whether the CT scanner 304 stores or transfers Protected Health Information (PHI). If the CT scanner 304 stored PHI and faced a cyber-event compromising PHI of patients, the entity owning or operating the connected CT scanner 304 could face legal and/or regulatory/compliance costs.

Further according to aspects of the present disclosure, the process 300 involves computing a composite risk score 324 to represent cybersecurity risk faced by the network connected CT scanner 304 based on the values of the parameters 316 included in the risk profile 314 using an algorithm 322. The composite score 324 can be derived either by simply using the Quality Function Deployment (QFD) method or by using an advanced algorithm 322 depending on the situation and availability of resources. The numeric value of the composite score 324 in the FIG. 3 is not the actual value. A fictitious number is used for the convenience of explaining the process 300.

Moreover, the process 300 involves actively monitoring the parameters 316 and their values with changing conditions. The risk score 324 could change with changing parameter values resulting from changing environmental conditions.

In addition, the process 300 includes assigning at least one management action to each risk driving parameter 316 where feasible that either remediates or mitigates the risk or prescribes a response action if the risk materialized into an actual adverse event. For example, there are at least two management actions 334 assigned to access management 320 to reduce cybersecurity risk to the CT scanner 304. One of the management actions 334 involves requiring user sign-in 308 at the CT scan room 302 door 306 to restrict physical access to the system. Another management action involves requiring user sign-in to the CT scan console 310.

Further, the process 300 includes simulating expected risk scores 324 with scenarios of each management action 334 potentially being in place individually. It allows deriving expected reduction in risk score 332 with use of each potential management action 334. Each management action 334 also has an associated cost of implementation 330 assigned thereto.

In various embodiments, the process 300 derives expected ROI Index 328 associated with a management action using the expected reduction in risk score 332 and cost 330 of implementing the management action. One of the ways to derive the expected ROI Index is simply dividing the expected reduction in risk by the cost. The expected ROI Index can be scaled up or down. In the process 300 of FIG. 3 example, the ROI Index 328 is calculated by dividing the expected reduction in risk 332 by the cost 330 of a management action 334 and multiplying the resulting number by 1,000 for ease of use. Further, the process 300 derives expected ROI Indexes 328 for all potential management actions 334 associated with all parameters 316 in the risk profile 314 of the CT scanner 304. The process 300 involves prioritizing potential management actions 334 from highest to the lowest ROI Index 328. The prioritization can be represented via a rank 326 order where highest ROI Index management action can be ranked 326 top/first.

Further, the process 300 includes selecting at least one of the highest ROI Index 328 ranked 326, preferably the top ranked, management actions 334 as optimal solution(s) for risk management; the selection process may also depend on the budget availability.

The ROI Index values 328 and ranks 326 could change with changing parameter values 316. The monitoring of parameters 316 allows the risk management process 300 to be dynamic and adaptable over time.

Referring to FIG. 4, the method 400 can be used to derive a risk score for a risk category, and adjusting prioritization of management actions considering all risks in the category according to aspects of the present disclosure. Medical device cybersecurity is the risk category in this example with a hospital being a concerning entity with multiple departments. The method 400 uses risk scores 410 for all risk elements impacting a department in a hospital to derive a department level risk score. For example, CT scanner is one of the risk elements 402; its risk profile may include parameters indicating probability of risk materializing 406 and parameters indicating potential impact of the risk 408 if materialized. The other risk element 404 could be the actual network to which CT scanner 402 and other risk elements (i.e. medical devices) are connected. There could be network level parameters that indicate probability of risk materializing 406. For example, if it is a segregated network, the probability of risk materializing 406 would be lower. Similarly, if network were connected to a broader mission critical network, the impact of the risk 408 would be higher. Some of the network level management actions may include having intrusion detection capabilities, firewall, etc.

In addition, the process 400 involves computing department level risk score 412. The department level risk score 412 is derived by using all risk scores 410 of all risk elements impacting the department in an appropriate formula (e.g. summation, weighted average, etc.) that matches the situation closely. The ROI Indexes for the potential management actions may need to be recomputed 420 to update rankings 422 if prioritization from all potential management actions associated with all risk elements impacting the department is desired.

Similarly, the process 400 includes deriving a risk score for the category 416 by using department level risk scores 410 and the most suitable algorithm 414. The ROI Indexes for all of the potential management actions may need to be updated 426 using a simulation method to derive new rankings 424 (or the priority orders) for the potential management actions. It would allow prioritizing from all of the potential management actions to ensure the best ROI in risk management efforts.

Some entities, for example, may have multiple hospitals requiring a category risk score to be derived further by looking at risk scores at hospital level. In some instances, the entity may only be operating at the department level e.g. imaging center, orthopedic ambulatory surgery center; in such cases, department level risk scores could be taken as the category level risk scores. Hence, the method 400 can serve as a mechanism to go up or down different levels for prioritizing risk management activities based on the complexity of an entity.

According to various aspects of the present disclosure, the category risk scores and ROI Indexes for all management actions can further be normalized 108 (FIG. 1) by the normalization factors 112 (FIG. 1) to prioritize the most optimal management actions that provide the best ROI from all risk categories.

Miscellaneous

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects. Furthermore, aspects of the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, a portable computer diskette, a hard disk, a random access memory (RAM), a read-only memory (ROM), an erasable programmable read-only memory (EPROM), Flash memory, a portable computer disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer storage medium is not a transient propagating signal, as such.

A computer readable signal medium may include a propagated data signal with computer readable program code embodied therein, for example, in baseband or as part of a carrier wave. A computer readable signal medium is not a computer readable storage medium.

Computer program code for carrying out operations for aspects of the present disclosure may be written in any combination of one or more programming languages. The program code may execute entirely on the user's computer, partly on the user's computer, as a stand-alone software package, partly on the user's computer and partly on a remote computer or entirely on the remote computer or server.

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes and systems for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be apparent to one with skills in the art that the optimization and prioritization in risk management of the invention may be provided using some or all of the mentioned features and components without departing from the spirit and scope of the present invention. It will also be apparent to the skilled artisan that the embodiments described above are specific examples of a single broader invention which may have greater scope than any of the singular description taught. There may be many alternations made in the descriptions without departing from the spirit of the present invention.

What is claimed is:

1. A process for optimal risk management comprising:
identifying a risk element;
building a risk profile for the risk element, wherein risk profile includes various parameters that either indicate or contribute to the probability of risk materializing and/or potential impact of the risk if it materialized;
computing a risk score based off of the parameter values in the risk profile;
monitoring the parameter values, managing the risk profile, and updating the risk score with changing environmental conditions;
assigning potential management actions impacting risk driving parameters where feasible;
recomputing potential risk scores (i.e. simulating) considering if each management action were implemented individually;
calculating ROI Index for each management action based upon potential reduction in risk score and cost of implementing the management action;
creating a priority order for each management action based upon its ROI Index value;
selecting one or more management action(s) from the highest ROI Index (i.e. high priority order) management actions for implementation considering resource availability to manage risk associated with the risk element; and
updating the risk score, and relevant aspects of the risk profile depending upon on what management actions are implemented and their respective impact.

2. The process of claim 1 further comprising:
computing risk score for the risk category based off of the risk scores of each risk element therein, with a potential of calculating risk score at a sub-group level;
monitoring risk scores of all risk elements, and updating overall risk score for the risk category (and sub-group where applicable) with changing environmental conditions;
recalculating potential risk scores (i.e. simulating) for the overall risk category (and sub-group where applicable) considering if each management action were implemented individually;
recomputing ROI Index for each management action based upon potential reduction in risk category (and/or sub-group) risk score and cost of implementing the management action;
creating a priority order for all management actions assigned to all risk elements within a risk category (and/or sub-group where applicable) by comparing their respective ROI Indexes;
selecting one or more management action(s) from the highest ROI Index (i.e. highest priority orders) management actions for implementation considering resource availability (i.e. budget allocation) and other relevant constraints to manage category (and/or sub-group where applicable) risk; and
updating the category (and/or sub-group where applicable) risk score, risk scores of risk elements and relevant aspects of the risk profiles depending on the management actions implemented and their respective impact.

3. The process of claim 2 further comprising:
calculating normalization factor based upon potential risk in each category;
normalizing risk scores for each risk categories using the normalization factor;
recalculating potential normalized risk scores considering if each management action were implemented individually;
recomputing ROI Index for each management action based upon potential reduction in normalized risk score and cost of implementing the management action;
creating a priority order for all management actions across all risk categories by comparing their respective ROI Indexes;
selecting management actions from the highest ROI Index (i.e. highest priority orders) management actions for implementation considering resource availability (i.e. budget allocation) and other relevant constraints;
updating the normalized risk score, risk scores for the categories and risk elements, and relevant aspects of the risk profiles depending on the management actions implemented and their respective impact.

4. The process of claim 2 further comprising:
allocating risk management budget using probability-impact matrix or its close variant as an option to each risk category; and
prioritization and selection of management actions for implementation using the priority orders determined by the respective ROI Indexes.

5. The process of claim 1 further comprising:
maintaining records of all potential management actions and their respective expected ROI Index values for all risks considering if risk management took place at the risk element, category (and sub-group where applicable) and/or entity levels;
updating the records with changing environmental conditions and risk scores upon implementation of management actions; and
making the potential management actions list available for consideration and selection for risk management.

6. A process for optimal risk management in presence of historical event data comprising:
accessing a data source, the data source having a collection of historical event profiles, each event profile having information such as date of the event, description, root cause, and monetary value (i.e. loss) therein;
calculating probable number of events to occur from a given cause in an upcoming period of time with a given confidence level;
calculating expected value of potential impact (i.e. loss) from the event originating from a given cause with a certain confidence level in an upcoming period of time;
calculating risk from each cause in an upcoming period of time based off of probable number of events arising from a root cause and expected value of potential loss from an event from the root cause;
assigning potential management actions to manage risk arising from each root cause;
recomputing potential risk (i.e. simulating) considering if each management action were implemented individually;
calculating expected ROI from each management action based upon potential reduction in risk and cost of implementation;
selecting one or more management action(s) from the pool of highest ROI management actions for implementation considering resource availability to manage risk; and
updating risk values from each root cause to the residual risk values depending upon what management actions are implemented and their respective impact.
